(19) United States
(12) Patent Application Publication
(10) Pub. No.: US 2015/0154520 A1
(43) Pub. Date: Jun. 4, 2015

(54) Automated Data Breach Notification

(71) Applicant: CSR Professional Services, Inc., Jensen Beach, FL (US)

(72) Inventors: Warren Ross Federgreen, Jensen Beach, FL (US); Francine Ellen Sachs, Jupiter, FL (US)

(21) Appl. No.: 14/618,434

(22) Filed: Feb. 10, 2015

Related U.S. Application Data
(63) Continuation-in-part of application No. 14/092,273, filed on Nov. 27, 2013.
Application No. 14/092,273 is a continuation of application No. 13/743,931, filed on Jan. 17, 2013, now Pat. No. 8,626,671.
Application No. 13/743,931 is a continuation-in-part of application No. 13/435,126, filed on Mar. 30, 2012, now abandoned.

(51) Int. Cl. G06Q 10/06; G06Q 30/00

(52) U.S. Cl. CPC G06Q 10/063; G06Q 30/018

(57) ABSTRACT

A computer-implemented system for data breach compliance comprises memory for storing computer executable program code; and a processor. The code comprises code for receiving electronic breach information (“EBI”), the EBI relating to a data breach, the EBI comprising data type information, geographic information, and data format information; code for analyzing the geographic information to choose an applicable set of regulatory rules; code for applying the rules to determine if a harm analysis is required; if the harm analysis is required, code for performing the harm analysis; code for analyzing the breach information and the volume of harm to determine if the volume of harm exceeds a harm threshold; and code for analyzing the breach information, the rules and the volume of harm to determine whether a consumer must be notified about the data breach.

### PRIORITY

This application is a continuation-in-part of U.S. application Ser. No. 14/092,273, filed Nov. 27, 2013, which is a continuation of U.S. Non-Provisional Ser. No. 13/743,931, filed Jan. 17, 2013, now U.S. Pat. No. 8,626,671, which is a continuation-in-part of U.S. application Ser. No. 13/435,126, filed Mar. 30, 2012, the full disclosures of which are incorporated herein by reference in their entireties.

### BACKGROUND OF THE INVENTION

Many organizations obtain, store, and/or safeguard private information and/or data relating to individuals. Data breach events may occur in which private data becomes unprotected, is removed, is stolen, and/or otherwise transferred from the control of an organization. Breach events may result from, for example, the actions of malicious outside parties, accidental disclosure, and/or other causes. Upon the occurrence of a breach event, one or more entities including, for example, federal government, state government, foreign government, political union, law enforcement, private entity, and other entities may each require compliance with complex specific rules, regulations, and laws related to data breach reporting. Complying with all of the applicable laws, rules, and regulations upon the occurrence of a data breach event may therefore be cumbersome. The laws, rules and regulations may require the notification of consumers associated with the private information whose privacy has been breached.

### SUMMARY OF THE INVENTION

Briefly, aspects of the present disclosure are directed to methods and systems for data breach compliance. Organization related information may be received. Breach information relating to a data breach event of the organization may be received. The breach information may include, for example, breach event description information, compromised personally identifiable information, and remediation action information. A breach report may be generated based on the breach information, the organization related information, and one or more rules related to data breach. At least one reporting entity may be determined based on the organization related information, the breach information, and the one or more rules. The breach report may be output.

In accordance with one aspect of the invention, a computer-implemented system for data breach compliance is disclosed. The system comprises memory having at least one region for storing computer executable program code; and processor for executing the computer executable program code stored in the memory. The computer executable program code comprises code for receiving electronic breach information, the electronic breach information relating to a data breach, the breach information comprising data type information, geographic information, and data format information; code for analyzing the geographic information to choose an applicable set of regulatory rules; code for applying the applicable set of regulatory rules to determine if a harm analysis is required; if the harm analysis is required, code for performing the harm analysis, the harm analysis comprising assigning a first value of weight of a cause of the data breach, a second value of weight to a time elapsed since the data breach; and a third value of weight to known negative repercussions of the data breach, the first, second and third values of weight combined to produce a volume of harm; code for analyzing the breach information and the volume of harm to determine if the volume of harm exceeds a harm threshold; and code for analyzing the breach information, the applicable set of regulatory rules and the volume of harm to determine whether a consumer must be notified about the data breach.

In one aspect of the invention the system further comprises code for analyzing the applicable set of regulatory rules to determine the content of a consumer notice relating to the data breach. In one aspect, the method further comprises the step of instructing the computer to compose the consumer notice.

In one aspect of the invention the system further comprises code for analyzing the breach information and the applicable set of rules to determine a required act of consumer notification, and displaying the required act of consumer notification in a checklist. In one aspect, the system further comprises code for permitting a user of the system to purchase a service related to the required act.

In one aspect of the invention, a non-transitory computer readable storage medium having computer executable instructions which when executed by a computer cause the computer to perform operations is disclosed. The operations comprising: receiving electronic breach information, the electronic breach information relating to a data breach, the breach information comprising data type information, geographic information, and data format information; analyzing the geographic information to choose an applicable set of regulatory rules; applying the applicable set of regulatory rules to determine if a harm analysis is required; if the harm analysis is required, performing the harm analysis, the harm analysis comprising assigning a first value of weight of a cause of the data breach, a second value of weight to a time elapsed since the data breach; and a third value of weight to known negative repercussions of the data breach, the first, second and third values of weight combined to produce a volume of harm; analyzing the breach information and the volume of harm to determine if the volume of harm exceeds a harm threshold; and analyzing the breach information, the applicable set of regulatory rules and the volume of harm to determine whether a consumer must be notified about the data breach.

In one aspect of the invention, the medium further comprises computer executable instructions which when executed by a computer cause the computer to analyze the applicable set of regulatory rules to determine the content of a consumer notice relating to the data breach. In one aspect of the invention, the medium further comprises computer executable instructions which when executed by a computer cause the computer to compose the consumer notice. In one aspect of the invention, computer executable instructions which when executed by a computer cause the computer to perform the operations comprising: analyzing the breach information and the applicable set of rules to determine a required act of consumer notification, and displaying the required act of consumer notification in a checklist.

In one aspect of the invention, the medium further comprises computer executable instructions which when executed by a computer cause the computer to permit a user to purchase a service related to the required act.

This SUMMARY is provided to briefly identify some aspects of the present disclosure that are further described below in the DESCRIPTION. This SUMMARY is not intended to identify key or essential features of the present disclosure nor is it intended to limit the scope of any claims.

The term “aspects” is to be read as “at least one aspect.” The aspects described above and other aspects of the present disclosure described herein are illustrated by way of example(s) and not limited in the accompanying figures.

### BRIEF DESCRIPTION OF THE DRAWINGS

A more complete understanding of the present disclosure may be realized by reference to the accompanying figures in which:

FIG. 1 is a flowchart of a method according to aspects of the present disclosure;

FIG. 2 is a flow diagram depicting operations of a method according to aspects of the present disclosure;

FIG. 3 is a flow diagram depicting operations of a method according to aspects of the present disclosure;

FIG. 4 is a flow diagram depicting operations of a method according to aspects of the present disclosure;

FIG. 5 depicts an aspect of the present disclosure in which breach information is received;

FIG. 6 is a flow diagram depicting an aspect of the present disclosure in which a determination is made with respect to whether consumer notification is required;

FIG. 7 is a flow diagram depicting an aspect of the present disclosure in which requirements for consumer notification are determined;

FIG. 8 is a flow diagram depicting a method for determining a harm threshold in accordance with an aspect of the present disclosure;

FIG. 9 is a flow diagram depicting an aspect of the present disclosure in which consumer notification is customized; and

FIG. 10 is a schematic diagram depicting a representative computer system for implementing and exemplary methods and systems for performing automated data breach compliance according to aspects of the present disclosure.

The illustrative aspects are described more fully by the Figures and detailed description. The present disclosure may, however, be embodied in various forms and is not limited to specific aspects described in the Figures and detailed description.

### DETAILED DESCRIPTION OF ASPECTS OF THE INVENTION

The following merely illustrates the principles of the disclosure. It will thus be appreciated that those skilled in the art will be able to devise various arrangements which, although not explicitly described or shown herein, embody the principles of the disclosure and are included within its spirit and scope.

Furthermore, all examples and conditional language recited herein are principally intended expressly to be only for pedagogical purposes to aid the reader in understanding the principles of the disclosure and the concepts contributed by the inventor(s) to furthering the art, and are to be construed as being without limitation to such specifically recited examples and conditions.

Moreover, all statements herein reciting principles and aspects of the disclosure, as well as specific examples thereof, are intended to encompass both structural and functional equivalents thereof. Additionally, it is intended that such equivalents include both currently known equivalents as well as equivalents developed in the future, for example, any elements developed that perform the same function, regardless of structure.

Thus, for example, it will be appreciated by those skilled in the art that any block diagrams herein represent conceptual views of illustrative circuitry embodying the principles of the disclosure. Similarly, it will be appreciated that any flow charts, flow diagrams, state transition diagrams, pseudocode, and the like represent various processes which may be substantially represented in computer readable medium and so executed by a computer or processor, whether or not such computer or processor is explicitly shown.

The functions of the various elements shown in the Figures, including any functional blocks labeled as “processors,” may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read-only memory (ROM) for storing software, random access memory (RAM), and non-volatile storage. Other hardware, conventional and/or custom, may also be included.

Software modules, or simply modules which are implied to be software, may be represented herein as any combination of flowchart elements or other elements indicating performance of process steps and/or textual description. Such modules may be executed by hardware that is expressly or implicitly shown.

Unless otherwise explicitly specified herein, the drawings are not drawn to scale.

Methods and systems of the present disclosure may aid an organization (e.g., a business entity, government entity, non-profit organization, and/or other type of organization) in complying with state, federal, international, private sector, industry, and other entity rules, laws, and regulations in the event of a data breach. A breach event as discussed herein may refer to a data breach event, a suspected data breach event, or any other similar occurrence.

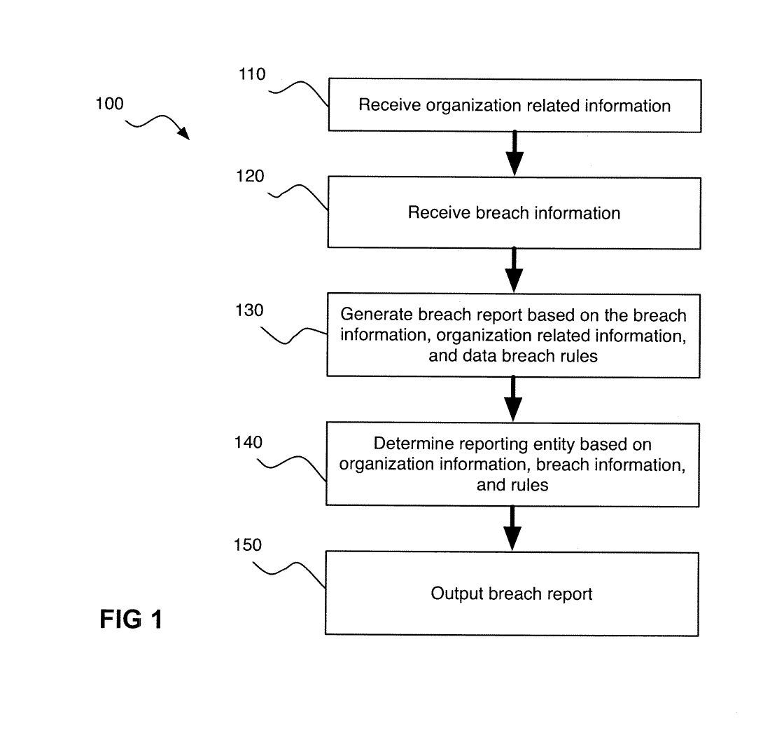

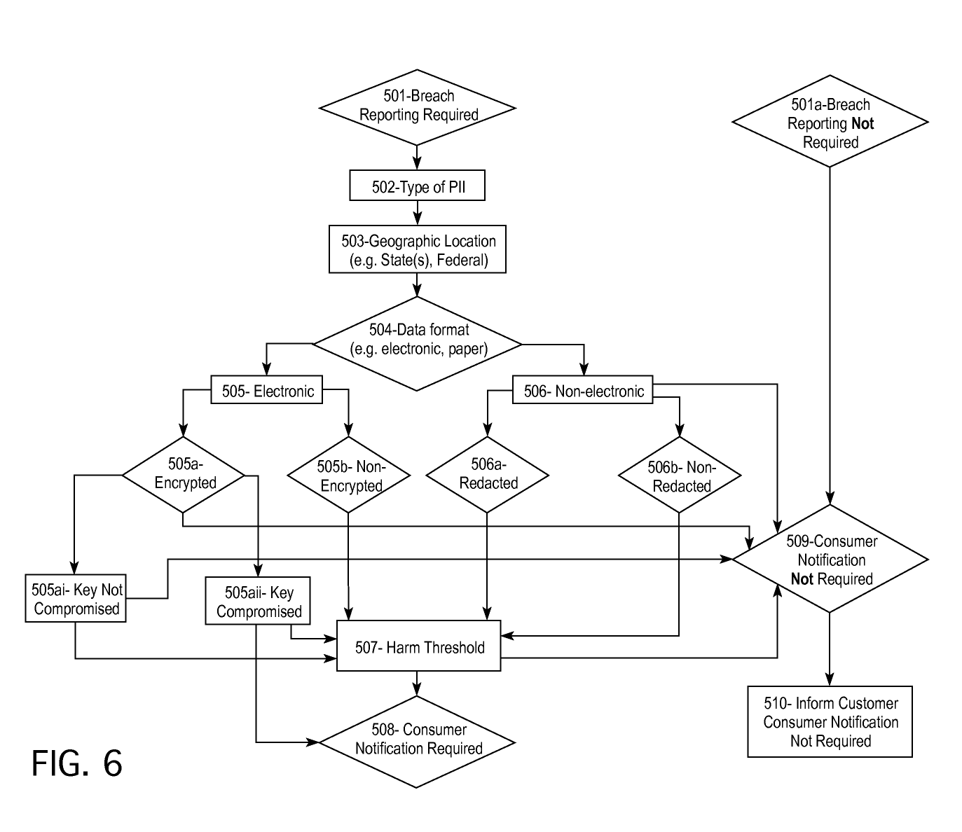

In FIG. 1, there is shown a flowchart 100, which defines steps of a method according to aspects of the present disclosure. Methods and systems of the present disclosure may be implemented using, for example, a computer system 400 as depicted in FIG. 6 or any other system and/or device.

In operation 110, organization related information may be received. An organization may be, for example, a business, a group, a not-for-profit organization, a governmental entity, education based organization, a financial services organization, health care related organization, and/or any other type of organization. The organization related information may include information describing, representative of, and/or relating to an organization. Organization related information may include, for example, organization name(s), address(es), telephone number(s), web address(es), Email address(es), date of founding, representative name(s), and other information related to the organization. Organization related information may include, for example, geographic locations (e.g., cities, states, regions, countries, or any other type of location) in which an organization engages in business. Organization related information may include description of activities of the organization, types of business the organization engages in, whether the organization is active or inactive, whether the organization is engaged in E-commerce, whether the organization participates in one or more states' Electronic Benefits Program (EBT), and/or any other information relating to the organization.

In some aspects, an organization may, for example, store information related to one or more individuals. An organization may, for example, store information in an electronic storage location, physical storage location, and/or any other type of storage. The stored information may include, for example, personally identifiable information (PII) related to one or more individuals.

In some aspects, organization related information may be received from a user via an input/output device (e.g., input/output structure 440 of FIG. 6). A user may, for example, enter information into system using a keyboard, pointer device, mouse, microphone, camera, and/or any other type of input device. In some aspects, organization related information may be received from a system, device, and/or apparatus separate from system 400. Organization related information may, for example, be transferred to system 400 over any suitable communication medium (e.g., the internet) in, for example, a data file. In some aspects, information regarding a breach event may be communicated over the phone, and a representation of the telephone communication (e.g., a phone conversation) may be received as breach information.

In operation 120, breach information related to a data breach event of the organization may be received. The breach information may include, for example, breach event description information, compromised PII, and remediation action information. A breach event may occur in many different circumstances in which information is transferred to, moved to, altered by, disclosed to, and/or otherwise accessed by a third party. A breach event may be the result of, for example, theft, trespass, loss, and/or other type of wrongdoing. A breach event may also occur inadvertently.

Breach event description information (e.g., a description of the breach event) may include, for example, a description of a breach event or suspected breach event. Breach event information may include, for example, names of persons associated with review of the breach event. Breach event information may, for example, include date(s) on which the breach occurred, estimated or actual time(s) at which the breach occurred, estimated or actual time(s) at which the breach is suspected to have occurred, date and/or time(s) at which the breach was discovered, location(s) of breach event, a description of the breach event, and/or any other information related to the breach event. Breach event information may include equipment related to the breach event. Equipment related to the breach event may include, for example, electronic data storage equipment (e.g., on computer(s), laptop(s), mobile device(s), server(s), hard-drive(s), portable storage device(s), thumb drive(s), USB device(s), CD(s), DVD(s), tape(s), and/or or any other electronic storage location and/or media), physical storage equipment (e.g., a vault, locked room, protected room, safe, and/or other physical storage equipment). Breach event information may include information representing impact on parties and/or entities associated with and/or related to the organization (e.g., data hosting companies, middleware software applications, business associates, banks, financial institutions, merchant service providers, or other parties). Breach event information may include, for example, a description of the facts associated with the event including whether the breach event was a loss or theft of a device and/or media, an internal system breach, a result of insider wrongdoing, an external system breach (e.g., hacking, cracking, and/or theft), an inadvertent disclosure, and/or any other type of event.

Compromised PII may include, for example, information disclosed, stolen, removed, compromised, acquired, and/or otherwise interfered with as a result of the breach event. PII may include, for example, information that may be used to uniquely identify, contact, and/or locate a single individual. PII may include, for example, name, date of birth, social security number, driver's license number, credit card number, debit card number, check routing number, check transit number, bank account numbers, tax identification numbers, personal identification number(s) (PIN), security code(s), access code(s), medical information, and/or any other type of information that may be used to uniquely identify an individual. Compromised PII may include a list of individuals, number of individuals, or other data representing the individuals affected by a breach event. By way of example, compromised PII may include names, residence information (e.g., address, city, state, and/or country of residence), type(s) of PII disclosed (e.g., a name or other personal identifier and social security number, driver's license number, financial account number, credit card number, etc.), and possibly other information representative of individuals affected by the data breach.

Remediation action information may include, for example, information relating to actions taken and/or performed by an organization in response to a breach event. In response to a breach, an organization may, for example, perform actions including notifying entities (e.g., law enforcement authorities, credit card companies, parent company, affiliates, customer(s), bank(s), ISO/Merchant service provider(s), government entities, and/or other entities as discussed below), performing internal investigation(s), conducting internal audit(s), and/or any other action(s) taken by an organization in response to a breach event. An organization may, for example, confiscate equipment related to the breach event. An organization may, for example, respond to a breach event by changing data storage policies, increasing security measures, altering data storage locations, increasing protection of stored information, and performing other actions. Remediation action information may include, for example, a description of actions performed, date and time of actions performed, and possibly other information.

In some aspects, breach information may be received in an input field (e.g., in a web browser, word processing application, or other type of application) from a user. Breach information may alternatively be received at, for example, system 400 as a text file (e.g., comma separated values file), spreadsheet, or other type of data file. Text received at system 400 may be organized and/or separated into breach event description information, compromised PII, and remediation action information using text recognition, data mining, or other techniques.

In some aspects, information regarding a breach event may be received through an application programming interface (API), for example, associated with the system 400. For example, an API may be provided to an organization (e.g., a financial institution). The API may be included in (e.g., embedded in) a secure web-page, for example, accessible only by representatives of the organization. Upon detection of a breach event, breach information may be entered by the organization (e.g., the financial institution) into data entry fields within the API.

In some aspects, audio representative of breach information may be received and the audio may be converted to text using a speech-to-text conversion operation or any other suitable audio conversion operation. By way of example, a user may provide audio (e.g., a voice recording, a voicemail message, a recorded phone call) including information related to a data breach. The audio may be received by, for example, system 400 and may be converted to text using any suitable speech-to-text operation. The text may be organized and/or separated by system 400 into breach event description information, compromised PII, and remediation action information. The text may be organized and/or separated using text recognition, data mining, or other techniques. For example, audio may be converted to text, and the text may be searched for one or more keywords, phrases, or terms. The keywords, phrases, or terms may, for example, relate to the breach event description, PII, remediation action information, or other information associated with data breach. The text may be categorized into breach event description information, compromised PII, and remediation action information based on the results of the search.

In operation 130, a breach report may be generated based on the breach information, the organization related information, and rules related to data breach (e.g., data breach reporting rules). For example, a breach report may be or may include a document, populated form, table, audio recording, video, and/or any other medium for presenting information. A breach report may, for example, include organization related information, breach event description information, compromised PII, remediation action information, and other information organized in a predetermined format. The predetermined format may, for example, be dictated by applicable data breach reporting rules (e.g., state laws, federal laws, private entity rules), clarity considerations, and/or other factors. In some aspects, the predetermined format may be determined based on applicable international (e.g., European Union (EU) and/or foreign country) data breach reporting rules and/or regulations.

Rules related to data breach may be, for example, federal laws (e.g., federal privacy laws); federal regulations (e.g., federal privacy regulations); federal court opinions; federal trade commission (FTC) administrative decisions and consent decrees; state laws; state regulations; state attorney general consent decrees; company privacy policies; industry policies; international privacy laws (e.g., EU privacy laws or any country's privacy laws); international regulations (e.g., EU privacy regulations or any country's privacy regulations); international court decisions and/or opinions; and/or any other rules, regulations, statutes, laws and/or guidelines.

In some aspects, a breach report may be generated based on the organization related information, breach information, and rules related to data breach. The organization related information, breach information, and rules related to data breach may be used to, for example, determine the rules applicable to a specific data breach event of an organization. The one or more data breach reporting rules, organization related information, breach information, and possibly other information may, for example, be stored in a database and organized into matrices or any other suitable data structure. In order to determine the rules related to data breach applicable to a specific data breach event, organization related information, breach information, and potentially other information may be compared to rules related to data breach (e.g., stored in a database). Text searching, data comparison, and other operations may be used to determine rules applicable to the data breach. Conditional logic may, for example, be used to determine which of one or more data breach reporting rules may be applicable based on the organization related information, the breach information, and possibly other information. In some aspects, a decision tree, graphical model, or other suitable approaches may be used to determine applicable data breach reporting rules.

In operation 140, at least one reporting entity may be determined and/or selected based on the organization related information, breach information, one or more rules, and possibly other information. A reporting entity may be, for example, a federal government agency (e.g., Office for Civil Rights, Office of Health and Human Services, Secret Service, and/or any other government agency), a state government agency (e.g., Office of the Attorney General for a state, Office of Cyber Security, Department of State Division of Consumer Protection, State Department of Health, or any other state government agency), international government agency (e.g., an EU and/or foreign government agency) private entity (e.g., a credit card company, a business, an organization, and/or any other private entity), an individual (e.g., an individual affected by the data breach event), and/or any other entity.

At least one reporting entity may be determined and/or selected based on the organization related information, breach information, and one or more rules applicable to data breach. There may be, for example, no single law (e.g., state law, federal law, international law, law of a foreign country, etc.), statute and/or regulation that governs an organization's obligations in the event of a data breach. Instead, there may be an evolving patchwork of international, federal, and states laws and regulations; E-transaction laws; evidentiary rules; industry standards; and other rules governing the use of personal information. Text searching, data comparison, and other operations may be used to determine rules applicable to the data breach. Conditional logic may, for example, be used to determine which of one or more data breach reporting rules may be applicable based on the organization related information, the breach information, and possibly other information. In some aspects, a decision tree, graphical model, or other suitable approaches may be used to determine applicable data breach reporting rules. Based on the applicable rules, at least one reporting entity may be determined and/or selected.

In some aspects, rules (e.g., federal laws, state laws, private entity rules, and/or any other rules) related to and/or applicable to data breach may be updated, modified, and/or altered. Updates to rules applicable to data breach may be received from, for example, subscription services, organizational memberships, news data feeds, and/or any other source of information. The information used to update applicable rules may, for example, be reviewed, monitored, curated, and/or supervised by a user (e.g., a subject matter expert in, for example, data breach compliance). Similarly, outdated information may be removed from a database of rules by, for example, system 400 and/or a user. A process of determining a reporting entity may be updated and/or refined based on additions, changes, and/or modifications to rules related to and/or applicable to data breach.

In some aspects, the reporting entities associated with a breach report may be determined based on remediation action information. For example, if the remediation action information indicates that an entity has been notified, that entity will not be selected or determined to be a reporting entity.

According to some aspects, reporting entities may be determined based on at least one geographic location associated with the data breach event. The at least one geographic location may be based, for example, on organization related information, breach information, and one or more rules related to data breach. By way of example, if the organization is a business incorporated in and/or having a presence in a specific state, that state's laws may be applicable to a data breach event of that organization. Similarly, if PII related to individuals who reside in a certain state is breached and that state's laws include long reach and/or long arm provisions extending its jurisdiction to other states, that state's laws may be applicable to the data breach event. If, for example, compromised PII includes information related to residents of multiple countries and/or countries other than the United States, international laws (e.g., EU or foreign country rules and regulations) may be applicable to a data breach event of that organization.

According to some aspects, reporting entities may be determined and/or selected based on one or more types of breached data. One or more types of breached data may be determined based on, for example, compromised PII. For example, compromised PII may include health care related information (e.g., medical records) associated with one or more individuals. State laws, federal laws (e.g., Health Insurance Portability and Accountability Act of 1996 (HIPAA), Health Information Technology for Economic and Clinical Health (HITECH)), federal agency regulations, and other rules applicable to health care privacy and/or security may be deemed applicable. A reporting entity may, for example, be determined based on applicable rules and the type of data breached. For example, federal, state, international, foreign country, and possibly other health care related agencies may be deemed reporting entities.

In operation 150, a breach report may be output. A breach report may, for example, be output to a user of system 400. A breach report may, for example, be output to a reporting entity (e.g., crime enforcement agency, federal government agency, state agency, foreign government agency, private entity, credit card company, and/or other type of entity).

In some aspects, a list or other data structure including one or more reporting entities and addresses associated with the reporting entities may be generated based on the organization related information, the breach information, and the rules related to the data breach event. A breach report may be output to the reporting entities at the addresses. An address associated with an reporting entity may be, for example, a mailing address, an email address, a website address, an file transfer protocol (FTP) site, or any other type of address. The breach report may be output to the reporting entity at the address by, for example, transmitting the report to the address via email, electronic file transfer (e.g., FTP file transfer), or using other approaches. The breach report may be output as one or more physical documents, a digital file, or any other format.

In some aspects, a database may be updated to include received organization related information, breach information, and a generated breach report. The database may include information relating to multiple organizations, multiple data breach events, and other related information. The database may be used to analyze information related to breach events. In some aspects, a request for one or more breach reports related to a selected organization may be received. In response to the request, a list of breach reports related to a selected organization may be generated based on the organization related information, the breach information, and one or more breach reports in the database.

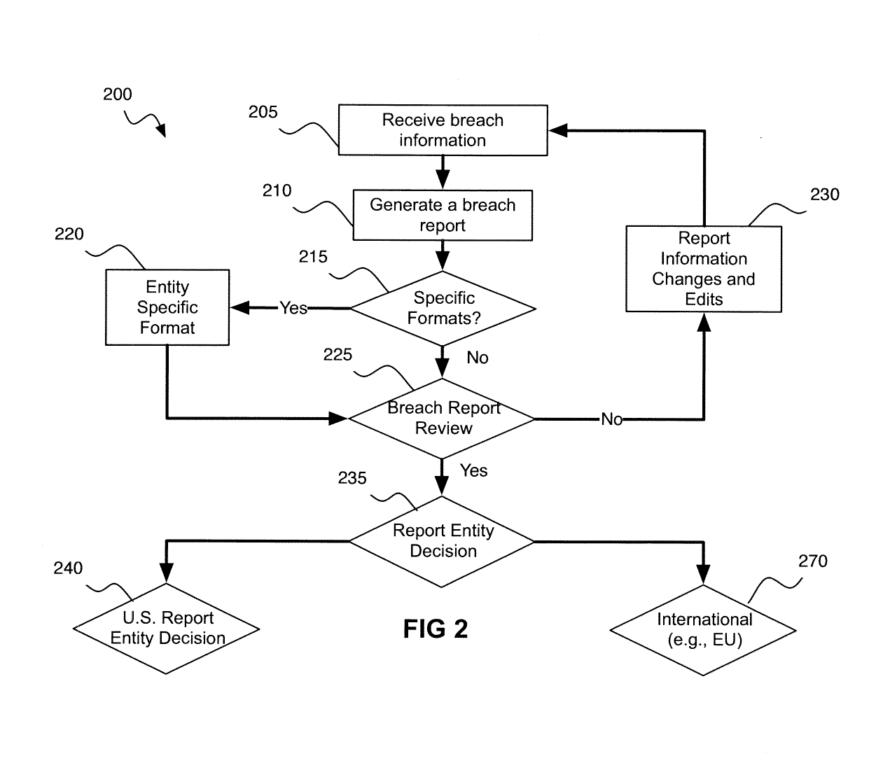

In FIG. 2, there is shown a flow diagram 200, which defines steps of a method according to aspects of the present disclosure. Organization related information may be received and, in some aspects, stored during an account or profile creation operation. An account or profile associated with an organization may be generated to include organization related information (e.g., name of organization, contact information, and other information as discussed previously in connection with FIG. 1).

In response to a data breach event or suspicion of a data breach event, breach information may be received 205 by, for example, system 400. As described above, a breach report may be generated 210 based on the stored organization related information, breach information, and rules related to data breach. Based on a comparison of the organization related information, the breach information, and rules related to data breach, it may be determined 215 whether the breach report is in a proper format. In some aspects, whether a breach report is in a proper format may be determined based on, for example, state rules, federal rules, international rules (e.g., EU regulations), industry standards, or other rules applicable to the breach event. For example, rules related to data breach reporting in New York, North Carolina, some federal agencies, and possibly other entities may require breach reports be generated in an entity specific format. An entity specific format may be, for example, a form including predetermined data entry fields or any other type of format. A breach report may be generated and/or modified 220 to conform to an entity specific format.

In some aspects, a breach report may be reviewed 225 to ensure that the breach report includes correct information, complete information, correctly formatted information, and otherwise conforms to a predefined set of standards. In a review operation 225, a breach report may be output to, for example, a user, to a system external to system 400, and/or any other system or device for review. Modified and/or updated organization related information and breach information may be received 230 by, for example, system 400. Modified organization related information and modified breach information may be generated by, for example, system 400 in an error detection and/or correction operation performed on the breach report. Modified organization related information and modified breach information may be generated by a user (e.g., a breach report review specialist) based on, for example, a review of the breach report. The breach report may be updated based on the modified organization related information and modified breach information. A breach report may be updated by, for example, generating a breach report 210 based on modified organization related information, modified breach information, and data breach reporting rules.

In some aspects, at least one reporting entity may be determined or selected 235 based on the organization related information, the breach information, and one or more rules. If, for example, the data breach occurred in the United States and/or affected United States citizens, residents, and/or people located in the United States, at least one reporting entity may be determined or selected 240 based on rules related to the U.S. federal government, state government(s), and/or other entities. If, for example, the data breach occurred in a country other than the U.S. and/or affected non-U.S. citizens, residents, and/or people located outside the United States, at least one reporting entity may be determined 270 based on rules related to the one or more political unions (e.g., the European Union), foreign government(s), state government(s), and/or other entities.

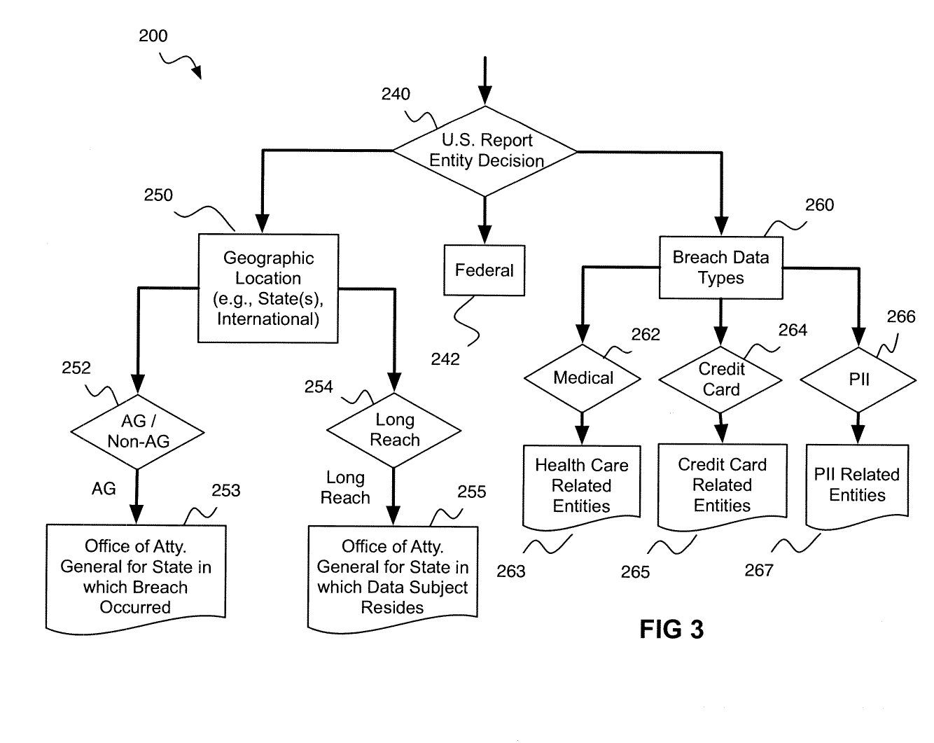

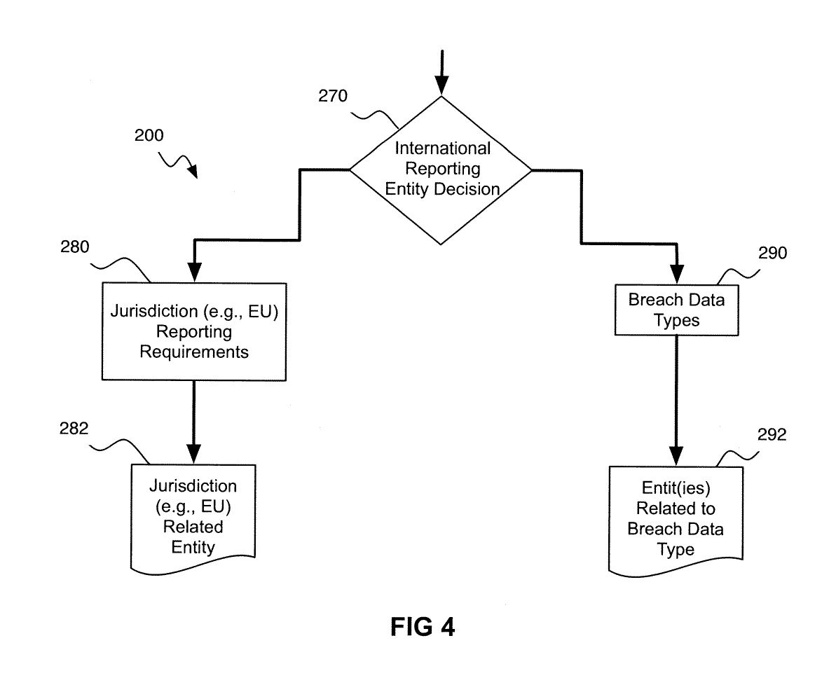

In FIG. 3, there is shown a flow diagram 200, which defines steps of a method according to aspects of the present disclosure. The flow diagram shown in FIG. 3 may, in some aspects, be associated with the flow diagram(s) shown in FIG. 2 and/or FIG. 4 below. The flow diagrams shown in FIG. 2, FIG. 3, and/or FIG. 4 may, for example, constitute one flow diagram depicting the steps of a method according to aspects of the present disclosure.

According to some aspects, when a data breach occurs in the United States and/or affects United States citizens, residents, and/or people located in the United States, at least one reporting entity may be determined or selected 240 based on rules related to the U.S. federal government, U.S. state government(s), and/or other entities. In some aspects, if the data breach occurred in the United States and/or affected United States citizens, residents, and/or people located in the United States, the federal government (e.g., Federal Bureau of Investigation and/or other agencies within or associated with the federal government) may require notification, reporting, and/or consultation 242 regarding the breach within a predetermined period of time. A breach report may be output 242 to an entity associated with the U.S. federal government.

According to some aspects, a reporting entity may be determined or selected 250 based on a geographical location associated with the breach. A geographical location associated with the breach event may be, for example, a state in which an organization is located, where a business is incorporated and/or registered, a state in which facilities and/or equipment owned by the organization are located (e.g., offices, retail locations, manufacturing facilities, server location(s)), and/or a state which is otherwise related to the organization and/or to the breach event. A geographical location associated with the breach event may be, for example, a state, county, or other location where an individual affected by the breach resides, is domiciled, or is otherwise located. It may, for example, be determined whether the geographic location associated with the breach event is in the United States, one or more states, or any other geographic region.

In some aspects, reporting entities may be determined or selected 252 based on attorney general reporting rules (e.g., included in rules related to a data breach event) for a state (e.g., a geographical location). Whether any attorney general reporting rules are applicable may be determined based on the attorney general rules related to a data breach event. Some states may, for example, require consultation, reporting, and/or notification of the attorney general of that state. And, some states may require reporting to the attorney general's office of that state, for example, within a set period of time (e.g., within five days of discovery of the breach or any other period of time), if the breach occurred in that state (e.g., the organization is located in that state, equipment associated with the breach is located within that state, etc.). The breach report may be output 253 to at least one reporting entity determined or selected based on attorney general report rules.

In some aspects, reporting entities may be determined or selected 254 based on long reach and/or long arm attorney general reporting rules (e.g., included in rules related to a data breach event) for a state (e.g., a geographical location). Rules related to a data breach event (e.g., long reach rules) for some states may require consultation, reporting, and/or notification of the attorney general of that state if a resident of that state or predetermined number of residents of that state are affected by a data breach. The breach report may be output 255 to at least one reporting entity determined or selected based on long reach and/or long arm attorney general reporting rules for a state.

According to some aspects, one or more reporting entities may be determined or selected 260 based on one or more types of breached data. One or more types of breached data may be determined based on, for example, compromised PII, breach event description information, organization related information, or any other information related to the breach event.

In some aspects, one or more reporting entities may be determined or selected 262 based on whether the breached data includes health care related information. Health care related information (e.g., medical records, patient records, prescription records, and/or other health care related information or data) and health care related laws, regulations, and rules (e.g., HIPAA, HITECH, or other health care related laws) may be applicable to the data breach event. Based on the applicable health care related rules, at least one reporting entity associated with health care (e.g., Office of Civil Rights, Office of Health and Human Services, Secret Service regional office, and/or other entities) may be determined and/or selected. And a breach report may be output 263 to a reporting entity associated with health care.

According to some aspects, one or more reporting entities may be determined or selected 264 based on whether the breached data includes credit card related information. Credit card related information may include, for example, credit card number(s), credit card personal identification number(s), or other information. The credit card related information may be associated with one or more credit card companies (e.g., American Express, Visa, MasterCard, Discover, or any other credit card company), and credit card company rules may be applicable to the data breach event. Based on the credit card company rules, at least one credit card company may be deemed and/or selected as a reporting entity. And a breach report may be output 265 to the credit card company (e.g., a reporting entity).

According to some aspects, one or more reporting entities may be determined or selected 266 based on whether the breached data includes PII. When breached data includes, for example, PII, certain federal, state, international, private entity, and/or other types of rules, regulations, and laws may be applicable. Based on the applicable rules, regulations, and laws, at least one reporting entity (e.g., the Secret Service and/or any other entity) may be determined 266, and the breach report may be output 267 to the at least one PII related reporting entity.

In FIG. 4, there is shown a flow diagram 200, which defines steps of a method according to aspects of the present disclosure. The flow diagram shown in FIG. 4 may, in some aspects, be associated with the flow diagram(s) shown in FIG. 2 and/or FIG. 3. The flow diagrams shown in FIG. 2, FIG. 3, and/or FIG. 4 may, for example, constitute one flow diagram depicting the steps of a method according to aspects of the present disclosure.

According to some aspects, when a data breach occurs in a country other than the U.S. and/or affects non-U.S. citizens, residents, and/or people located outside the United States, at least one reporting entity may be determined or selected 270 based on rules related to the one or more political unions (e.g., the European Union), foreign government(s), state government(s), and/or other entities.

In some aspects, if the data breach occurred outside of the United States and/or affected non-U.S. citizens, residents, and/or people located outside the United States, an entity associated with a foreign government (e.g., the EU) may require notification, reporting, and/or consultation regarding the breach within a predetermined period of time.

According to some aspects, a reporting entity may be determined and/or selected 280 based on an international jurisdiction associated with the breach. An international jurisdiction associated with the breach event may be, for example, a political union (e.g., the EU), a foreign country, and/or state in a foreign country in which an organization is located, where a business is incorporated and/or registered, in which facilities and/or equipment owned by the organization are located (e.g., offices, retail locations, manufacturing facilities, server location(s)), and/or which is otherwise related to the organization and/or to the breach event. An international jurisdiction associated with the breach event may be, for example, a political union (e.g., EU), country, state, or other location where an individual affected by the breach resides, is domiciled, or is otherwise located. It may, for example, be determined whether the geographic location associated with the breach event is in Canada, the EU, or any other geographic region.

In some aspects, a breach report may be output 282 to one or more reporting entities (e.g., jurisdiction related reporting entities) that are determined or selected based on rules associated with the international jurisdiction. For example, a breach report may be output to one or more reporting entities determined and/or selected based on data breach reporting rules associated with the EU (e.g., EU data breach reporting rules). The one or more reporting entities may be, for example, associated with one or more countries in the EU.

According to some aspects, a reporting entity may be determined or selected 290 based on one or more types of breached data. One or more types of breached data (e.g., health care related information, credit card related information, PII) may be determined based on, for example, compromised PII, breach event description information, organization related information, or any other information related to the breach event. One or more reporting entities may be determined 290 based on the one or more types of breached data and rules associated with the one or more types of breached data in the international jurisdiction, country, state, or other entity. A breach report may be output 292 to the entity associated with the type of breached data.

According to some aspects, one or more types of breached data may include PII, and certain international jurisdiction rules (e.g., EU rules) other types of rules, regulations, and laws related to PII may be applicable. Based on the applicable rules, regulations, and laws related to PII, at least one reporting entity (e.g., an EU related entity) may be determined 290, and the breach report may be output 292 to the at least one reporting entity.

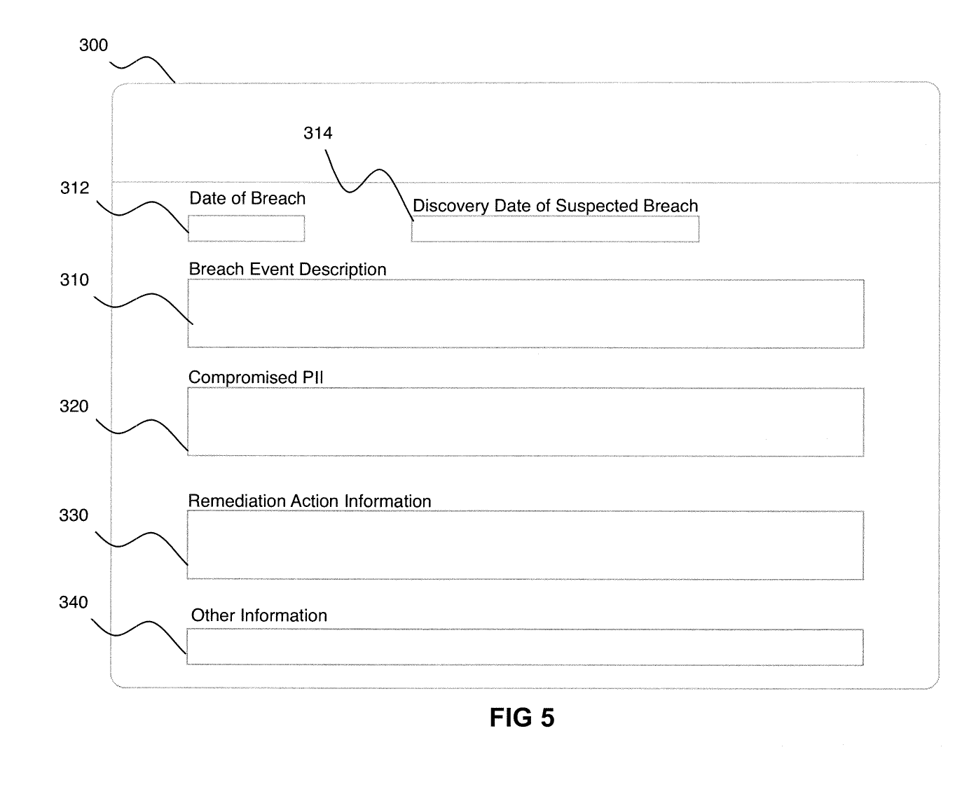

FIG. 5 depicts an aspect of the present disclosure in which breach information is received. Breach information may be received from a user in a data entry interface 300 (e.g., one or more data entry fields in a webpage, online form, etc.). The breach information may include breach event description information 310, compromised PII 320, remediation action information 330, and possibly any other information 340 related to the breach event. Breach event description information 310 may include, for example, a date of the breach event 312, a date of discovery of the breach event or suspected breach event 314. Breach event information may, for example, be received in one or more data entry fields including a breach event description field 310, a compromised PII entry field 320, a remediation action entry field 330, an other information entry field 340, and possibly other data entry fields.

According to some aspects, the data entry interface 300 may be generated based on previously received organization related information, breach event description information, compromised PII, remediation action information, or other information. The data entry fields in the data entry interface 300 may be generated based on the previously received information from an organization. For example, if an organization has previously provided information relating to, for example, a previous data breach, the one or more data entry fields may be generated to include greater or fewer data entry fields based on the previously provided information. The one or more data entry fields may, for example, be customized based on the previously provided information. One or more custom data entry fields may, for example, prompt a user to input specific information relating to or derived from the previously provided information. Modifying the one or more data entry fields based on previous breach events related to an organization may ensure that the data fields are specifically tailored to the organization.

In some aspects, one or more data entry fields (e.g., data entry fields 310, 312, 314, 320, 330, 340) in the data entry interface 300 may be pre-populated based on previously received breach event description information, compromised PII, remediation action information, and possibly any other information related to a previous breach event associated with the organization. A user may, for example, be prompted to check the accuracy of and edit one or more of the pre-populated data entry fields.

In some aspects, the data entry interface 300 including one or more data entry fields may be generated based on breach information associated with one or more additional organizations. For example, if breach information is received from multiple related organizations (e.g., businesses, organizations, or entities in the same industry), data fields for one organization may be generated based on the breach information previously received from other related organizations.

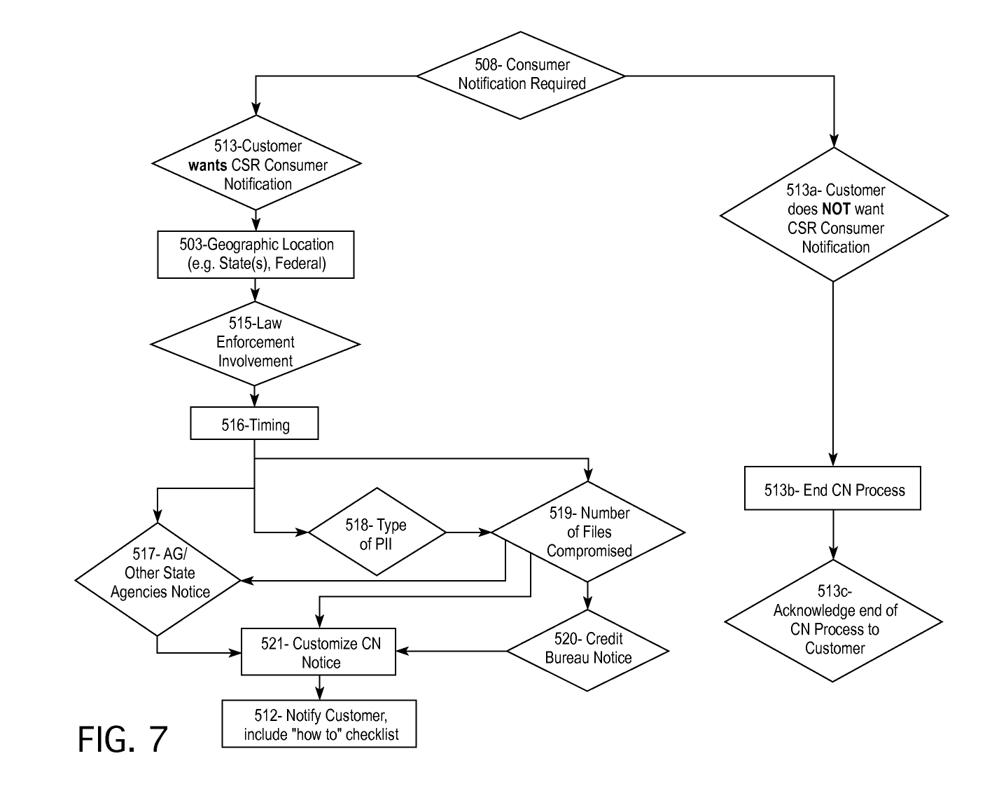

FIGS. 6 and 7 show a flow chart in accordance with one aspect of the present disclosure. The flow charts represent a method of determining whether Consumer Notification is necessary when a data breach occurs, and the method of creating the notification when it is necessary. Based on the data captured in the breach reporting analysis as discussed above, a decision as to whether a breach warrants reporting to authorities (“Reporting”) occurs using the methodology outlined above. Consumer Notification (“CN”) is only required if the decision is made that reporting is required to the appropriate authorities as shown in steps 501 and 501a. Consumer notification is not required in all cases where reporting to authorities is required, and it is therefore important to determine when consumer notification is required. If breach reporting is not required 501a, then CN is also not required 509, and once the system determines that breach reporting is not required, and CN is therefore not required, the system informs the customer that CN is not required 510.

In the event breach reporting is required 501, the determination of whether CN should occur is based on a number of variables as shown in items 502-507. These items include the Type of PII 502, Geographic Location 503, Data Format (e.g. electronic vs paper) that was breached 504, What was compromised and how 505a, 505ai, 505aii, 505b, 506a, 506b, and Harm Threshold 507.

The first variable type is Type of PII 502. There are many types of PII, and the type of PII that is the subject of the breach is an important factor in determining whether CN is required. PII encompasses a broad, and ever expanding, list of items. Breach of some specific items, like health data, or certain financial data, triggers the involvement of Federal regulators. The list of different types of PII continues to expand and must be continually reviewed and updated. In one aspect, the present disclosure will allow for a flexible decision/rules engine that will allow for the addition of new variables and applying the variables for more extensive analysis, therefore determining what needs to be done based on the type of PII has been breached.

There are 5 types of PII recognized as the Federal Standard: Driver's License, Date of Birth, Social Security number, Credit/Debit card number, and ACH/routing and transit number. More common contact information, eg. Address, email, phone, etc. would be considered basic PII. “Sensitive” information includes Criminal records, and certain health conditions—AIDS, Hepatitis, STD's.

The second variable is Geographic Location 503. Analysis of this variable includes long reach rules, and rules differ based on state regulations. CN is required predominantly based on the state(s) in which the business is located, and the state(s) in which the business' consumers reside. Currently, 47 states have specific laws covering data breaches and the requirements for CN. These laws stipulate that if CN is required and a consumer is a resident of their state their residents must be notified, regardless of the domicile of the business.

In step 503, the system reviews the laws of the state(s) and Federal regulations that impact the CN to determine the specific requirements of the notice and notice process. It determines who should be notified, based on the following: 1: In steps 502-507 State notification: does state law require notification. 2: In steps 502 and 504-507, Federal notification: does federal law require notification? Based on the geographic location 503 and the state law, it may be important to know the data format 504. If the data format is electronic 505, it may be important to determine whether the data was encrypted 505a, and, if so, whether the key was compromised 505ai or not 505aii. If the data format is non-electronic 506, it may be important to determine if sensitive information in the data is redacted 506a or not 506b. If the data is not electronic 506, then the system determines that consumer notification is not required under the laws of 41 states whose laws are specifically written to cover electronic data only. However, if the 6 other states are involved, or if the federal government is involved, then further analysis is required for non-electronic data, which will be discussed in detail below.

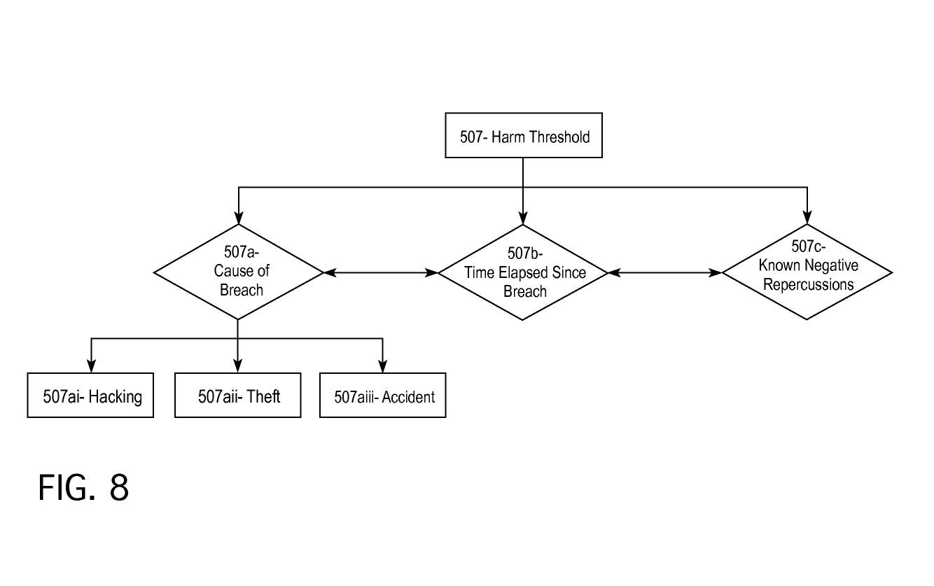

If the data is electronic 505, or if federal regulations are involved, the system queries if the data was encrypted 505a or not 505b. If not 505b, an analysis of the harm threshold is performed, which is discussed in detail below. If the data was encrypted 505a, then the system queries whether there was a compromise of the encryption key 505ai and, depending on the answer and the effected states, the system makes a determination regarding whether CN is required. All of this information is evaluated by the harm threshold 507 (shown in further detail in FIG. 8), and a determination is made regarding whether consumer information is required 508.

Turning now to FIG. 7, if CN is required 508, the customer is asked whether the customer wishes to have the system notify consumers. If not 513a, the system may presume that the customer will notify consumers as required but will not use the system to do so. In this event, the CN process is ended 513b and the end of the process is acknowledged to the customer, e.g., via the user interface. If the customer does want the system to notify consumers 513, the geographic information from step 503 in FIG. 6 is used, e.g., to determine the applicable law.

The system asks whether law enforcement is involved in step 515. If Yes, the system determines whether the state has provisions that notice may/must be delayed, and, if so, what delay notice is involved based on state of incident. If law enforcement is not involved, the system then determines whether there are timing requirements for CN 516, such as minimum required notice is assessed; “without unreasonable delay” or state specific timing requirements. For example, the system would know that if Maine is one of the affected states, notice must occur within 7 days.

Once the system has reviewed the laws of the state, it determines whether the state has an expanded definition of PII. If yes, the system reviews state specific requirements for data definition and determines if the data is categorized as PII. For example, the system would know that California and Texas have expansive definitions that specify name in any format, telephone numbers, etc. qualify as PII. The system uses this information and the type of PII to determine what the rules require for CN. If none of the states in question have expanded definition of PII, then no custom CN is required.

The system will automatically generate an email and notify the end user of their consumer notification results and remediation requirements, if required. If CN is required, the email will have additional information that will offer CN notification services and data requirements 512. A Customized Checklist is generated (based on state requirements) and attached to email 512, 521.

If state and/or federal regulations require notice of event to be sent to various agencies, those notifications are added to checklist. Timing of notification is the driver of first order of behavior. The timelines for notification 516 and state and/or federal agencies to be notified are predictive or modified by secondary considerations determined based on the state agencies involved 517, number of files involved 519, and the credit bureaus involved 520. The identified agencies are then added to checklist along with timelines for their notification.

Turning now to FIG. 8, which is a more detailed depiction of the harm threshold analysis performed in step 507 of FIG. 6. The vast majority (40) of the state laws have language that stipulates that if the breach has not, or can be determined that it will not, cause harm, then CN is not required. Accordingly, the system performs a harm analysis. If the breach is in CA, GA, IL, MN, ND, TN, TX and DC or one of the Federal regulations is involved, CN may be required without regard to the harm analysis. A review of state and Federal specific language is performed to re-assess CN requirement.

If breach occurs in any of the other states and no Federal regulation is involved then the harm is evaluated. The harm threshold analysis includes analysis of the cause of the breach, e,g, giving more weight to a breach caused by hacking than by theft, and more weight to a breach caused by theft than by accident. The harm threshold analysis includes an evaluation of the Cause of the Breach 507a, which includes information relating to whether the cause was hacking 507ai, theft 507aii, or accident 507aiii. The harm threshold analysis also includes an evaluation of the Time Elapsed Since the Breach 507b. The system reviews the time elapsed since the breach occurs and assigns a weight that contributes to the overall level of harm. The analysis further includes analysis of Known Negative Repercussions 507c, in which the system reviews whether there have been any known negative repercussions and determines the appropriate weight to contribute to the overall level of harm.

The system considers Items 507a-507c individually and taken together to determine the appropriate weights for each. The more often the system goes through this particular iteration, it more accurately determines the weight factors for subsequent analyses. The solution has the ability to make intelligent decisions based on historical data. The system analyzes past occurrences to makes statistical determinations as to the likelihood of current harm threshold. The universe that represents the denominator in the formula expands directly in concert with the number of users. This represents “artificial intelligence” as the system learns from prior experience.

Turning now to FIG. 8, a flow chart is shown for determining specific requirements for CN after the system determines that CN is required.

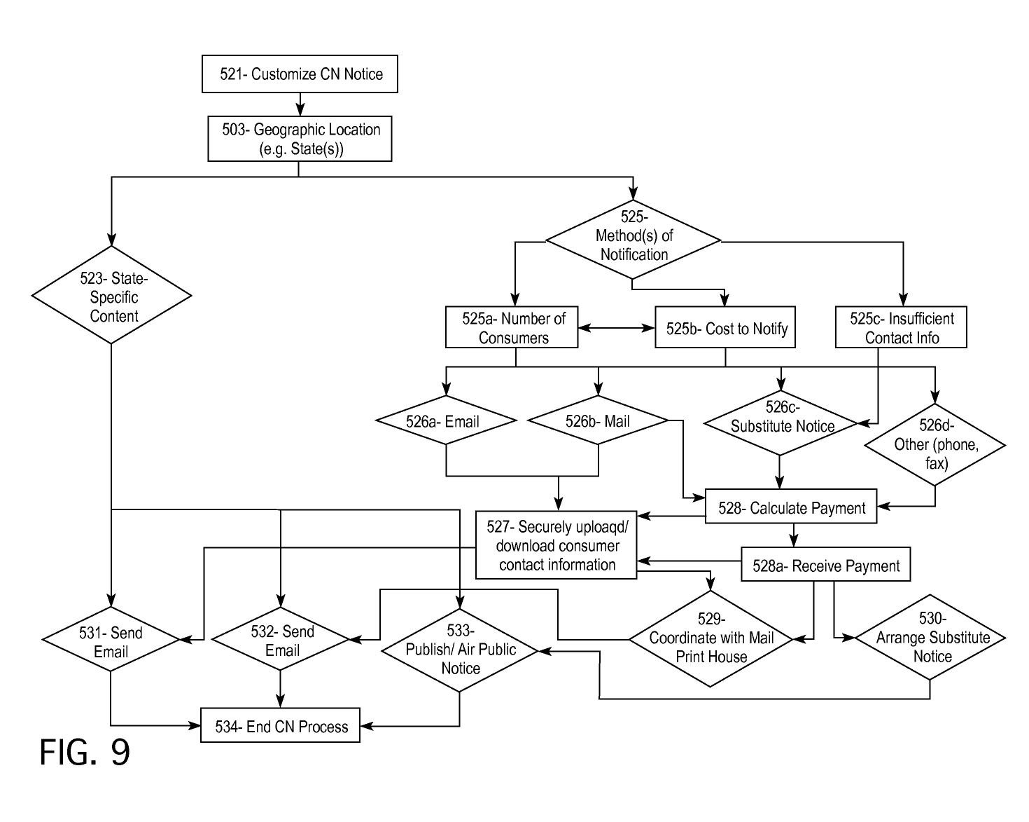

Turning now to FIG. 9, a flow chart is shown for generating customized consumer notifications. Some states and some Federal regulations have very specific requirements as to what content should, and should not, be included in the actual notice. While there is some commonality in these requirements across states, the end result is that state and Federal regulation will necessitate a customized notice. Additionally, state and Federal regulations have very specific requirements as to how notice must be provided. Thus, the system must analyze the content requirements and method of notice delivery specified for the states and federal regulations involved.

The system reviews the laws of the state(s) and Federal regulations that impact the CN 503 to determine the specific content requirements and method of notice delivery process. Based on state and various Federal regulations, system will generate very specific language dictating what facts must be covered and exclude all that must NOT be in the notice 523 different variables must be taken into consideration. Custom content specifics are also added to the checklist.

The system then determines a notification method 525-526. Does state and/or federal requirements allow for email notification? 525a, 525b, 526a. If so, Does the state require proper consent or is email the primary method of communication? If primary or if the consumer has consented, a CN Service option is added to the checklist. If not primary or if the consumer has not consented, e-mail is not an option. If the state and/or federal requirements does not allow for e-mail notification, Email Notification is not required or not allowed, therefore not an option.

If Mail notification 525a, 525b, 526b is required, add as a CN Service option and add to the checklist. If not, mail notification is not required, therefore, add to the checklist as an option that does not have to be done but can be done if the customer prefers.

If Substitute Notification 525a, 525b, 525c, 526c is allowed, the system asks how many consumers were effected? 525a, and what are the state regulations in regard to substitute notification and number of consumers effected? If this test results in substitute service being allowed, add as a CN Service option and add to the check list. Otherwise it is not an option.

The system next asks whether the cost for “traditional” notifications exceeds the regulatory thresholds? 525b. If Yes: Add as a CN Service option and add to checklist. If No: Not an option—need to select traditional means.

The system then asks if the user has sufficient consumer contact information 525c. If Yes, review of other state regulations to verify that substitute notification is still an option is required. If no, add as a CN Service option and add to the checklist

The system then asks whether the state allows for phone or fax notifications. If Yes: Add as CN Service option and add to checklist. If No: Not an option—need to select traditional means.

The system will allow an end user to review and accept notification services based on CN standards. Once accepted, end user will be required to submit additional information for the CN. Once accepted, end user will receive another email with a secure link requesting consumer data file 527. User will receive an invoice and pay online before CN processing begins 528, 528a. Payment receipt triggers email to be sent out with secure URL for file upload 528a, 527. Once file has been successfully uploaded CN processing will commence. 529-533. If substitute notification is selected system initiates notification so information can be accurately transmitted to the substitute notification source 530, 533.

End user may alternatively select that they do NOT want to purchase notification services from within the system, and will instead perform the required notification in another way. They must provide an electronic signature to elect this option. Once rejected user will be send another email confirming this choice 513c.

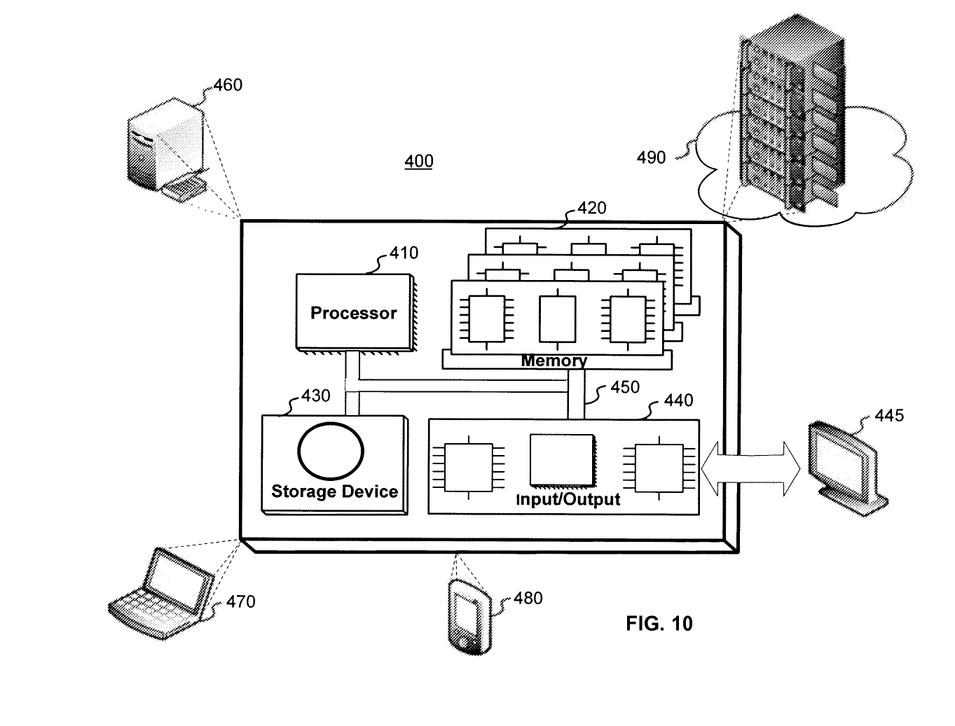

FIG. 10 shows an illustrative computer system 400 suitable for implementing methods and systems according to an aspect of the present disclosure. The computer system may comprise, for example, a computer running any of a number of operating systems. The above-described methods of the present disclosure may be implemented on the computer system 400 as stored program control instructions.

Computer system 400 includes processor 410, memory 420, storage device 430, and input/output structure 440. One or more input/output devices may include a display 445. One or more busses 450 typically interconnect the components, 410, 420, 430, and 440. Processor 410 may be a single or multi core.

Processor 410 executes instructions in which aspects of the present disclosure may comprise steps described in one or more of the Figures. Such instructions may be stored in memory 420 or storage device 430. Data and/or information may be received and output using one or more input/output devices.

Memory 420 may store data and may be a computer-readable medium, such as volatile or non-volatile memory, or any non-transitory storage medium. Storage device 430 may provide storage for system 400 including for example, the previously described methods. In various aspects, storage device 430 may be a flash memory device, a disk drive, an optical disk device, or a tape device employing magnetic, optical, or other recording technologies.

Input/output structures 440 may provide input/output operations for system 400. Input/output devices utilizing these structures may include, for example, keyboards, displays 445, pointing devices, and microphones—among others. As shown and may be readily appreciated by those skilled in the art, computer system 400 for use with the present disclosure may be implemented in a desktop computer package 460, a laptop computer 470, a hand-held computer, for example a tablet computer, personal digital assistant, mobile device, or smartphone 480, or one or more server computers that may advantageously comprise a “cloud” computer 490.

At this point, while we have discussed and described the disclosure using some specific examples, those skilled in the art will recognize that our teachings are not so limited. Accordingly, the disclosure should be only limited by the scope of the claims attached hereto.

1. A computer-implemented system for data breach compliance, comprising:
memory having at least one region for storing computer executable program code; and
processor for executing the computer executable program code stored in the memory, where the computer executable program code comprises:
a) code for receiving electronic breach information, the electronic breach information relating to a data breach, the breach information comprising data type information, geographic information, and data format information;
b) code for analyzing the geographic information to choose an applicable set of regulatory rules;
c) code for applying the applicable set of regulatory rules to determine if a harm analysis is required;
d) if the harm analysis is required, code for performing the harm analysis, the harm analysis comprising assigning a first value of weight of a cause of the data breach, a second value of weight to a time elapsed since the data breach; and a third value of weight to known negative repercussions of the data breach, the first, second and third values of weight combined to produce a volume of harm;
e) code for analyzing the breach information and the volume of harm to determine if the volume of harm exceeds a harm threshold; and
f) code for analyzing the breach information, the applicable set of regulatory rules and the volume of harm to determine whether a consumer must be notified about the data breach.

2. The system of claim 1, further comprising code for analyzing the applicable set of regulatory rules to determine the content of a consumer notice relating to the data breach.

3. The system of claim 2, further comprising code for composing the consumer notice.

4. The system of claim 1, further comprising code for analyzing the breach information and the applicable set of rules to determine a required act of consumer notification, and code for displaying the required act of consumer notification in a checklist.

5. The system of claim 4, further comprising code for permitting a user of the system to purchase a service related to the required act.

6. A non-transitory computer readable storage medium having computer executable instructions which when executed by a computer cause the computer to perform operations comprising:
a) receiving electronic breach information at a computer, the electronic breach information relating to a data breach, the breach information comprising data type information, geographic information, and data format information;
b) instructing the computer to analyze the geographic information to choose an applicable set of regulatory rules;
c) instructing the computer to apply the applicable set of regulatory rules to determine if a harm analysis is required;
d) if the harm analysis is required, instructing the computer to perform the harm analysis, the harm analysis comprising assigning a first value of weight of a cause of the data breach, a second value of weight to a time elapsed since the data breach; and a third value of weight to known negative repercussions of the data breach, the first, second and third values of weight combined to produce a volume of harm;
e) instructing the computer to analyze the breach information and the volume of harm to determine if the volume of harm exceeds a harm threshold; and
f) instructing the computer to analyze the breach information, the applicable set of regulatory rules and the volume of harm to determine whether a consumer must be notified about the data breach.

7. The medium of claim 6, further comprising computer executable instructions which when executed by a computer cause the computer to analyze the applicable set of regulatory rules to determine the content of a consumer notice relating to the data breach.

8. The medium of claim 7, further comprising computer executable instructions which when executed by a computer cause the computer to compose the consumer notice.

9. The medium of claim 6, further comprising computer executable instructions which when executed by a computer cause the computer to perform the operations comprising: g) analyzing the breach information and the applicable set of rules to determine a required act of consumer notification, and h) displaying the required act of consumer notification in a checklist.

10. The medium of claim 9, further comprising computer executable instructions which when executed by a computer cause the computer to permit a user to purchase a service related to the required act.
